(19) United States
(12) Patent Application Publication
(10) Pub. No.: US 2025/0246884 A1
(43) Pub. Date: Jul. 31, 2025

(54) TRANSMISSION LINE ADVANCEMENT SYSTEM

(71) Applicant: CONDUX INTERNATIONAL, INC., Mankato, MN (US)

(72) Inventors: Bradley Paul RADICHEL, Mankato, MN (US); Heinz U. WORTMANN, Mankato, MN (US); David J. HASSING, Mankato, MN (US)

(73) Assignee: CONDUX INTERNATIONAL, INC., Mankato, MN (US)

(21) Appl. No.: 18/878,519

(22) PCT Filed: Jun. 23, 2023
(86) PCT No.: PCT/US2023/068955

§ 371 Date: Dec. 23, 2024

Related U.S. Application Data
(60) Provisional application No. 63/355,571, filed on Jun. 24, 2022.

(51) Int. Cl. H02G 1/08

(52) U.S. Cl. CPC H02G 1/081

(57) ABSTRACT

The present disclosure relates to a transmission line installation system including a control unit comprising a processing device, a computer-readable storage device, a communication device, a display device, and at least one input device. The control unit is configured to display status information and to receive input from a user. A transmission line source is configured to supply a transmission line to an advancement device drive assembly. A are configured to receive a transmission line at a drive assembly first end and advance the transmission line into a conduit at a drive assembly second end, wherein the plurality of advancement devices comprise a sensor for measuring a speed of the transmission line as it is advanced by the plurality of advancement devices. A local controller is configured to communicate with local controllers positioned in other advancement devices via a global controller, wherein the local controllers are configured to communicate the measured speed of the transmission line as it is advanced through each of the plurality of advancement devices to each of the other plurality of advancement devices via the global controller. The local controllers are configured to receive the measured speed of each of the other local controllers via the global controller and synchronize the speed of the transmission line as it passes through each advancement device.

This application is being filed on Jun. 23, 2023, as a PCT International Patent application and claims the benefit of and priority to U.S. Provisional Patent Application No. 63/355,571, filed on Jun. 24, 2022, the entire disclosure of which is incorporated by reference in its entirety.

### BACKGROUND

Transmission lines are used for transmitting power or data signals. One type of transmission line is a fiber optic cable that can be used to transmit digital data using light signals. The use of fiber optic cable for data transmission is popular, at least in part due to the high data transmission rate and very fast transmission speed. Another type of transmission line is an electrical transmission line. Electrical transmission lines carry electrical current from one point to another in an electric power system.

Transmission lines can be used to carry power or data signals short distances, such as within a building, or long distances, such as between neighboring cities. For longer distance communication, cables may be installed in underground ducts, where continuous cables are desired between manhole, hand hole, or other access point locations.

Installation equipment such as line blowers and pullers have been developed that can be used to insert fiber optic cable into ducts over long distances. It is desired to have automated transmission line installation equipment which can facilitate smooth and stable advancement of a variety of transmission lines that are being installed.

Another type of conduit is a pipeline. Sometimes pipelines are constructed for a purpose, such as for transporting oil long distances. If the pipeline stops being used for the original purpose, it is desirable to repurpose the pipeline for other purposes.

### SUMMARY

The present disclosure relates to the installation of transmission lines with a transmission line advancement system. The transmission line advancement system is configured to install a variety of transmission lines into a conduit, pipe, duct, or the like, including fiber optic cables and electrical transmission lines.

In some embodiments the systems and methods of the present disclosure can be used to for long run installations of transmission lines, for example as long as 0.5, 1, 2, 5, 10 kilometers, or more.

Furthermore, the present disclosure relates to a transmission line advancement system that is configured to install the transmission lines into preexisting conduits such as oil pipelines. Installing transmission lines into preexisting conduits is desired to reduce the cost of developing above ground or underground transmission line systems.

Furthermore, the present disclosure relates to a transmission line advancement system that is configured to install transmission lines over very long distances to facilitate long-distance communication or transmission of electrical current. The installation of transmission lines over long distances is desirable because it minimizes the number of access points required to access the transmission line. It may also reduce the number of joints that are required between ends of two adjacent transmission lines. Reducing the number of joints between transmission line ends greatly reduces the cost of installing a transmission line while also greatly reducing the likelihood of faults that often occur at the joints, which can lead to power outages or other problems.

Further yet, the present disclosure relates to an advancement device including a control unit comprising a processing device, a computer-readable storage device, a communication device, a display device, and at least one input device, the control unit being configured to display status information and to receive input from a user; a transmission line source configured to supply a transmission line to an advancement device drive assembly; the advancement device drive assembly, the advancement device drive assembly configured to advance at least one transmission line through a conduit; a local controller, the local controller configured to control various components of the advancement device and communicate with a global controller, wherein the local controller is configured to communicate with other advancement devices via the global controller to synchronize the operation of a plurality of advancement devices; and a power source configured to power the local controller.

Further yet, the present disclosure relates to a transmission line installation system including a control unit comprising a processing device, a computer-readable storage device, a communication device, a display device, and at least one input device, the control unit being configured to display status information and to receive input from a user; a transmission line source configured to supply a transmission line to an advancement device drive assembly; a plurality of advancement devices, the plurality of advancement devices configured receive a transmission line at a drive assembly first end and advance the transmission line into a conduit at a drive assembly second end, wherein the plurality of advancement devices comprise a sensor for measuring a speed of the transmission line as it is advanced by the plurality of advancement devices; and comprise a local controller configured to communicate with local controllers positioned in other advancement devices via a global controller, wherein the local controllers are configured to communicate the measured speed of the transmission line as it is advanced through each of the plurality of advancement devices to each of the other plurality of advancement devices via the global controller, wherein the local controllers are configured to receive the measured speed of each of the other local controllers via the global controller and synchronize the speed of the transmission line as it passes through each advancement device.

Still further yet, the present disclosure relates to a method of retrofitting a pipeline with a power cable using a transmission line installation system, including accessing the pipeline at a first location through a first access point; operating a first advancement device at the first location to advance the power cable to a second location; connecting the power cable to a second advancement device at the second location; operating the second advancement device at the second location to advance the power cable to a desired location; using a plurality of sensors, measuring a speed of the transmission line at the first advancement device and the second advancement device as the transmission line passes through the first advancement device and the second advancement device; using a local controller at each of the advancement devices, communicating the measured speed with the other advancement devices along the transmission line installation system via a global controller; and using the local controller within each of the advancement devices, adjusting the speed of the transmission line as it passes through each of the advancement devices to a uniform speed.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

The following drawings are illustrative of examples of the present disclosure and therefore do not limit the scope of the present disclosure. Examples of the present disclosure will hereinafter be described in conjunction with the appended drawings, wherein like numerals denote like elements.

FIG. 1 is a schematic diagram illustrating an example transmission line installation system.

FIG. 2 is a block diagram of another example of the transmission line installation system of FIG. 1.

FIG. 3 is a side perspective view of an example advancement device within the transmission line installation system of FIG. 1.

FIG. 4 is a cross-sectional view of the example advancement device within the transmission line installation system of FIG. 1.

FIG. 5 is a side perspective view of a mobile cart including a transmission line storage and a winch.

FIG. 6 is a cross-sectional view of a transmission line installed within a conduit and a duct optionally installed within the conduit.

FIG. 7 is a block diagram illustrating exemplary communications within an example of the transmission line installation system shown in FIGS. 1-4.

FIG. 8 is a schematic block diagram illustrating an example of the local controller of a component of the transmission line installation system shown in FIG. 4.

FIG. 9 is a schematic block diagram illustrating another example of the local controller of a component of the transmission line installation system shown in FIGS. 4 and 8.

FIG. 10 is a flow chart illustrating a method for using a transmission line installation system to advance a transmission line into a conduit.

FIG. 11 is a flow chart illustrating a method for using a transmission line installation system including a plurality of advancement devices to advance a transmission line through a conduit.

FIG. 12 is a schematic diagram illustrating a step of the method of FIG. 11 wherein a first advancement device advances a transmission line below the ground.

FIG. 13 is a schematic diagram illustrating additional steps of the method of FIG. 11, wherein the transmission line is connected to a second advancement device, an advancement speed at the first advancement device and the second advancement device are synchronized, and then the first advancement device and the second advancement device further advance the transmission line through the conduit.

FIG. 14 is a schematic diagram further illustrating optional steps of the method of FIG. 11, wherein the transmission line may be connected to subsequent advancement devices after the second advancement device and further advanced through the conduit.

FIG. 15 is a schematic diagram illustrating the transmission line installation system 100 of FIGS. 1 and 14 including pull lines and a winch positioned at a second end of the transmission line installation system.

### DETAILED DESCRIPTION

Various examples will be described in detail with reference to the drawings, wherein like reference numerals represent like parts and assemblies throughout the several views.

The present disclosure relates to a transmission line installation system 100, which can be used to install a transmission line. The term “transmission line” is used herein as a generic term for any type of wire, cable, or other elongate structure capable of transmitting energy, whether in the form of a fiber optic cable, power line, electrical cable, telephone line (copper line), coaxial cable, or the like. For simplicity, the present disclosure refers to a particular example of a transmission line, namely an electrical power cable. However, the transmission line installation system can be used in the same manner for installation of any other transmission line, and therefore the present disclosure should not be interpreted to be limited to installation of power cables. Instead, the transmission line installation system can also be used for installing power lines, telephone lines, coaxial cables, and any other desired transmission line. In typical embodiments the transmission line installation system is configured to install a transmission line within a conduit such as a duct. Additionally, a transmission line installation system can also be used for other purposes, such as for installing a pull tape or other pull line, a duct, or other items within a conduit.

Although the term “transmission line” is sometimes used (such as in radio-frequency engineering) to refer to a specific type of line used to carry radio frequency signals, the term “transmission line” is not intended to be so limited in the present disclosure, but rather is intended to broadly include the transmission of any type of energy or signal (electricity, radio frequency, light, etc.) along an elongate and flexible structure. Specifically, examples of transmission lines include those that can transmit electricity, such as a wire; or light, such as a fiber optic cable including optical fibers.

The installation of power cables over very large distances requires a system that is configured to apply a large advancement force of at least 2,000 pounds. As applied to preexisting conduits such as an oil pipeline, this advancement force is ideally applied by an advancement device configured to push or pull a transmission line. Blowers might not be able to apply a sufficient advancement force because they are often configured to apply an advancement force of about 400 pounds. Further, existing conduits such as oil pipelines may include large, empty volumes that make it difficult to generate sufficient force with a blower, where the empty volumes are defined by the inner volume of the conduit less the volume of any components within the conduit. As applied to a blower, as the volume of a conduit is increased, the force per unit area of a two-dimensional cross section of that conduit is decreased. Examples of components that may be placed within the conduit are discussed herein, including ducts and transmission lines.

Although references herein are made to a duct, the installation of a duct is not required to install a transmission line. Transmission lines may be optionally installed within a duct to divide a larger conduit into smaller subsections. Therefore, other components that are used to install or mount a duct within a conduit are also not required, but may be optionally included within the transmission line installation system.

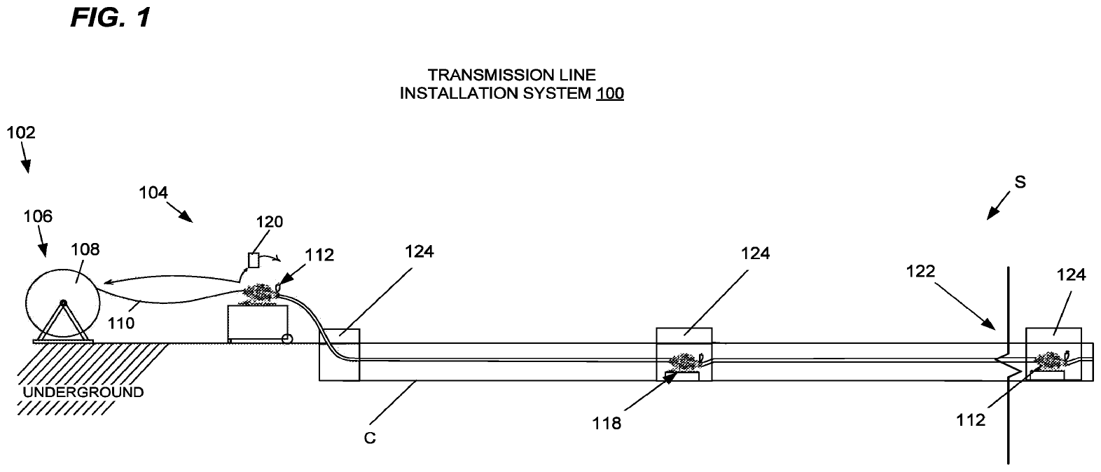

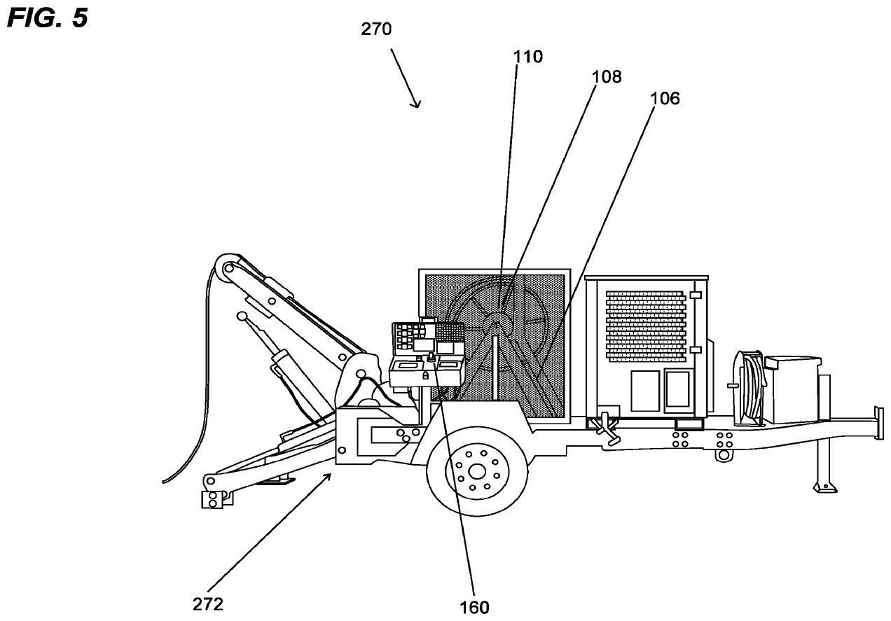

FIG. 1 is schematic diagram illustrating an example transmission line installation system 100 being used to install a transmission line 110 at a site S. In the illustrated example, the transmission line installation system 100 includes a transmission line source 102 and a transmission line conveying system 104. The example transmission line source 102 includes a reel stand 106 for holding a transmission line reel 108 containing a transmission line 110 (alternatively referred to herein as a transmission line). The example transmission line conveying system 104 includes an advancement device 112. Also shown in FIG. 1 is the transmission line installation site S includes a conduit C for receiving the transmission line 110. In certain examples, the conduit C is a preexisting conduit such as an oil pipeline. In some examples, the conduit C is positioned above the ground. An example transmission line source 102 is described in further detail with reference to FIG. 5.

The transmission line conveying system 104 is a machine that operates to install a transmission line 110 into the conduit C. Examples of transmission line conveying systems 104 include advancement devices 112 such as line puller systems, line pusher systems, or line blowing systems. The example shown in FIG. 1 shows an advancement device 112 including a line pusher/puller system. In some embodiments a transmission line conveying system 104 includes a combination of one or more line pushers and one or more line pullers. Additionally, in some embodiments an advancement device 112 includes a line puller, and in some embodiments a line puller system includes a line blower. The transmission line conveying system 104 can also include one or more other transmission line conveying apparatuses, alone or in combination

The reel stand 106 supports a reel 108 configured to store, dispense, and retract a transmission line 110 such as a power cable. The reel 108 may contain a large distance of transmission line 110 of at least 10,000 feet. An example reel stand 106 and reel 108 are illustrated and described in further detail with reference to FIG. 5.

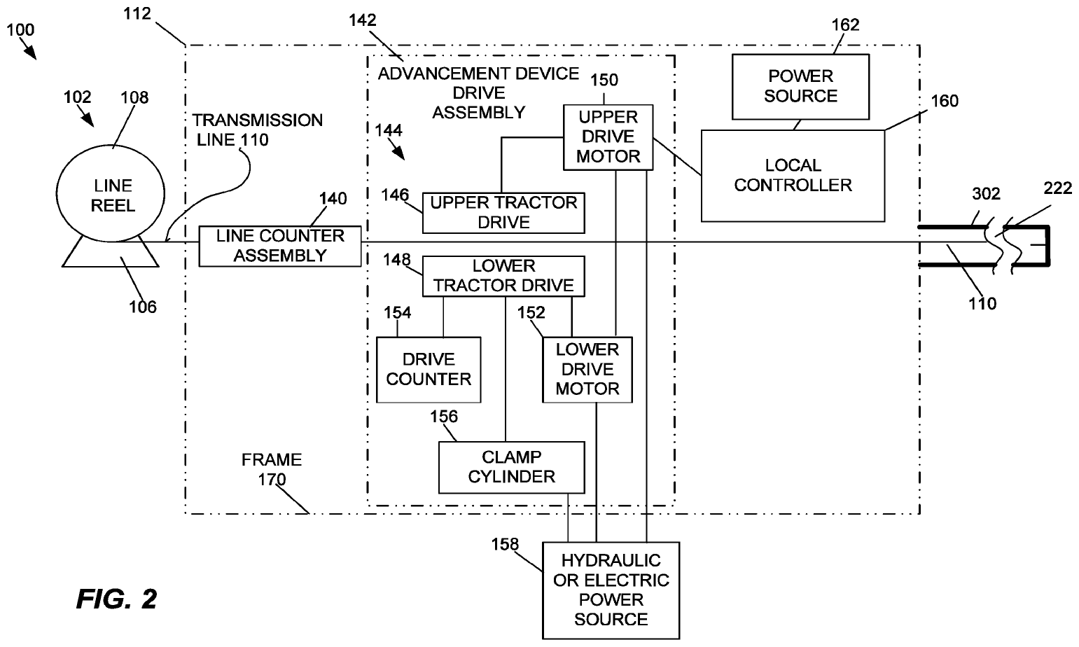

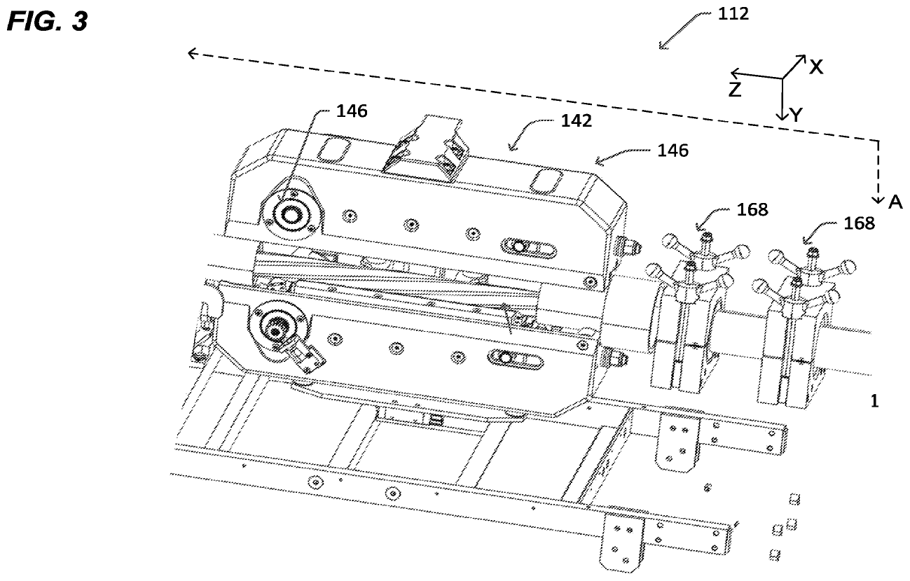

The advancement device 112 includes a plurality of components configured to advance a transmission line 110 through a conduit. In some embodiments, the installation system 100 can include a plurality of advancement devices 112 as shown in FIGS. 1, 13, and 14. An example advancement device 112 is illustrated and described in further detail with reference to FIGS. 2-3.

The transmission line installation system 100 is usable by one or more installation technicians to install a transmission line 110 into the site S.

In a typical scenario, one or more conduits are buried underground at a site S along a desired route prior to cable installation. The conduit includes access openings 124, which are openings in the conduit through which the interior of the conduit can be accessed. In some embodiments the access openings 124 are placed at predetermined locations based on a maximum estimated push or pull distance of the advancement device 112. As the push or pull distance of the advancement device 112 is increased, fewer access openings 124 are required, which significantly reduces the costs of installing a transmission line 110.

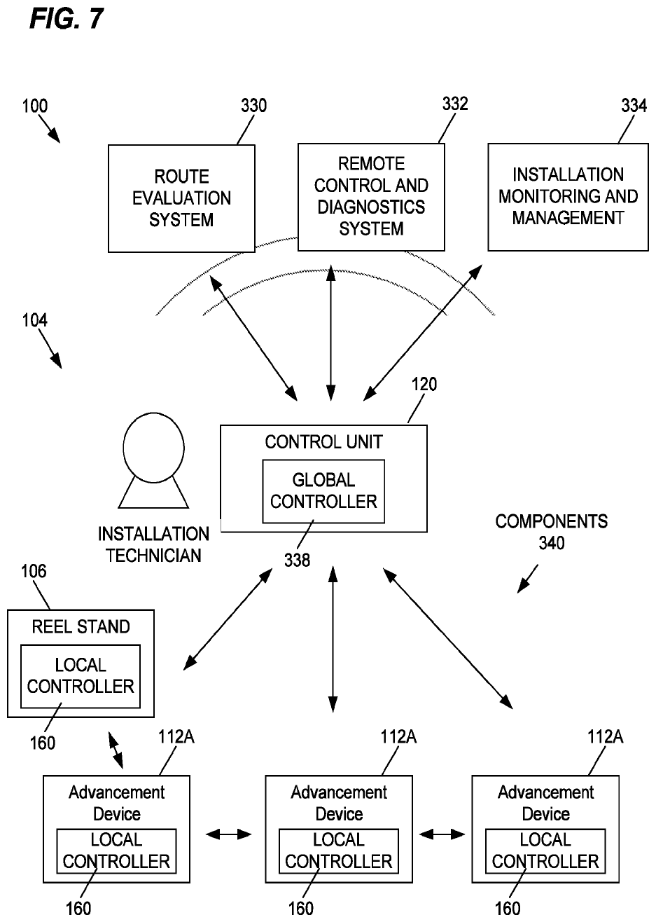

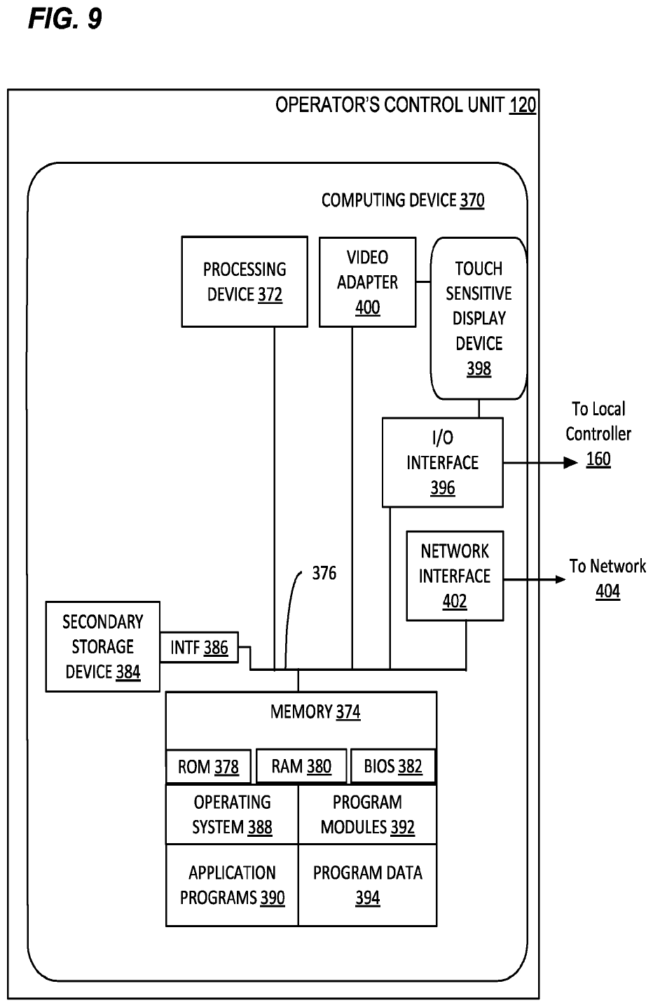

The transmission line installation system 100 further includes a control unit 120 configured to operate various components along the transmission line installation system 100. An example control unit 120 is illustrated and described in further detail with reference to FIGS. 7 and 9. The transmission line installation system 100 may include any number of advancement devices 112 placed along the length of the conduit C, as shown by the break 122.

FIG. 2 is a block diagram of another example of the transmission line installation system 100 of FIG. 1. The transmission line installation system 100 includes an advancement device 112 having a plurality of internal components. Transmission line 110 is provided by the transmission line source 102, which may include a reel stand 106 supporting a reel 108 for supplying transmission line to the advancement device 112.

The advancement device 112 includes a line counter assembly 140 for monitoring the length of the transmission line 110 passing through the advancement device 112 from the reel 108. Similar to the line counter discussed herein for the reel stand 106, the advancement device 112 can similarly include an optical counter that reads markings on the exterior of the transmission line 110 as it passes through the line counter assembly 140. The length is communicated to and received at the local controller 160, for communication to other components or the control unit 120.

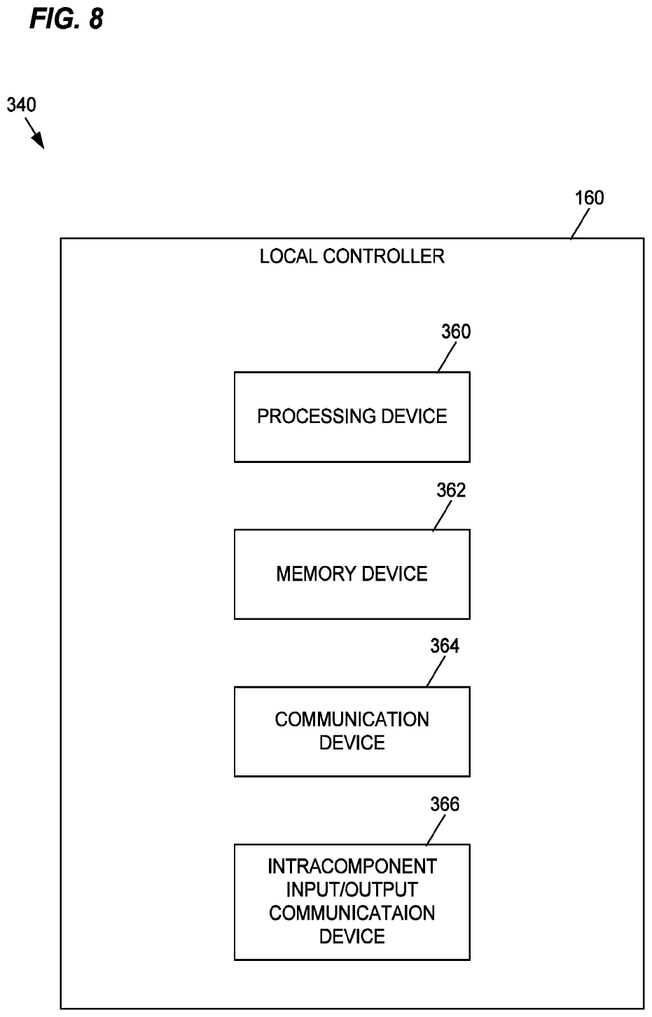

The local controller 160 is powered by a power source 162 that provides power to the local controller 160. The local controller 160 is illustrated and described in further detail with respect to FIG. 8.

The advancement device 112 further includes an advancement device drive assembly 142 configured to advance a transmission line through a conduit. The advancement device drive assembly 142 includes a tractor drive 144 including an upper tractor drive 146 and a lower tractor drive 148. Preferably, each is driven by a hydraulic, pneumatic, or electric drive motor, 150, 152. Each tractor drive 146, 148 includes a moveable member. In some embodiments, an endless chain in each tractor drive 146, 148 is driven by the drive motors 150, 152, respectively, so as to frictionally engage the transmission line 110 and apply the motive pushing force to the transmission line 110. In the illustrated embodiment, the tractor drives 146, 148 oppose each other and are aligned in the vertical direction. Other moveable drive members besides opposed endless chains are possible including wheels and/or belts. Further, the moveable members can be arranged in V-shape, for example.

The advancement device drive assembly 142 may include a lower drive counter 154 monitors movement of the lower tractor drive 148, which is indicative of the speed of advancement device drive assembly 142, and correspondingly indicative of the speed of the transmission line 110 as it enters the conduit C. Such speed monitoring is important for preventing excessive relative speed between the advancement device drive assembly 142 and the transmission line 110 during slippage, which occurs when the transmission line 110 travels at a speed that is greater than or less than the upper and lower tractor drives 146, 148. Additionally, the speed monitoring is also important so that it can be communicated to other components 340, such as to synchronize their operations (such as to keep several advancement devices 112 all operating at the same speed). The speed is communicated from the lower drive counter 154 to the local controller 160 which receives the speed measurement. The speed can then be communicated from the local controller 160 to other components or the control unit 120. Alternatively, the speed monitoring can be used to adjust the speed of the advancement device 112 so that it matches an instructed speed. For example, if the local controller 160 receives an instruction from a control unit 120, or a global controller to adjust to a certain speed of operation, the speed measurement can be used to determine whether the speed needs to be increased or decreased to match the instructed speed, and to confirm once the instructed speed has been achieved. This enables a plurality of advancement devices 112 to communicate with one another to synchronize and operate at a uniform speed. Operating at a uniform speed is desirable because it prevents segments of a transmission line 110 from traveling at non-uniform speeds, which may result in coiling. Coiling of a transmission line 110 may result in damage to the transmission line 110.

In some embodiments the advancement device drive assembly 142 further includes a hold down system, such as a clamp cylinder 156, linked to the hydraulic or electric power source 158 by a power line. The clamp cylinder 156 generates a predetermined normal force on the transmission line 110 between the upper and lower tractor drives 146, 148. Some slip is acceptable. Too much slip can cause transmission line jacket damage. Too much slip may also limit the usefulness of the advancement device 112 if insignificant push forces are generated. The conduit C usually contains some irregularities, joints and bends that can keep transmission line 110 from moving smoothly. Unless an appropriate normal force is generated (not too much slip), the pushing force may be inadequate to overcome the irregularities, and slip may occur too often, causing unnecessary transmission line jacket damage or insignificant transmission line push force. On the other hand, a normal force which is too high risks crush damage to the transmission line 110, and inadequate slippage, such that column damage will be more likely to occur as the advancement device drive assembly 142 continues to move the transmission line 110 when transmission line 110 is being slowed or stopped within the conduit C. When slip does occur under high normal force loads, transmission line jacket damage may result. By providing for a predetermined normal force with the advancement device 112, predetermined slip levels can be monitored. This results in an appropriate level of slip, so as to not cause too many shutdowns of the advancement device 112 when transmission line damage is not significantly at risk, but excessive slip is noted, and can be used to shut off the advancement device to prevent damage.

The transmission line 110 exits the advancement device 112 at an end opposite the reel 108 and goes into a conduit C. The break lines 222 in the conduit C indicate that the conduit and transmission line 110 may extend over large distances.

FIG. 3 is a side perspective view of an example advancement device 112 within the transmission line installation system 100 of FIG. 1. The advancement device 112 includes, among other things, an advancement device drive assembly 142. Some embodiments may further include one or more of a load cell 200, and a duct mount assembly 168 for securably mounting to a duct or conduit C at an end D1. As described above, the transmission line 110 advances through the advancement device drive assembly 142 and before entering the proximal end of the conduit C.

Some embodiments include a load cell 200, which is a force transducer that is configured to convert a force such as tension, compression, pressure, or torque into an electrical signal that can be measured and standardized. In some embodiments, the load cell 200 is located between the advancement device drive assembly 142 and the line counter assembly 140 (shown in FIG. 2), or other component such as a fixed frame member. The displacement of the advancement device drive assembly 142 relative to the line counter assembly 140 or fixed frame member results in either tension or compression of the load cell 200. Thus, the load cell 200 can measure a motive force, namely the drive force generated by frictional engagement of the transmission line 110 with the advancement device drive assembly 142, based on the tension or the compression of the load cell 200. This motive force may be communicated from one advancement device 112 to another via local controllers 160 over a control unit 120, as illustrated and described in further detail with reference to FIG. 7.

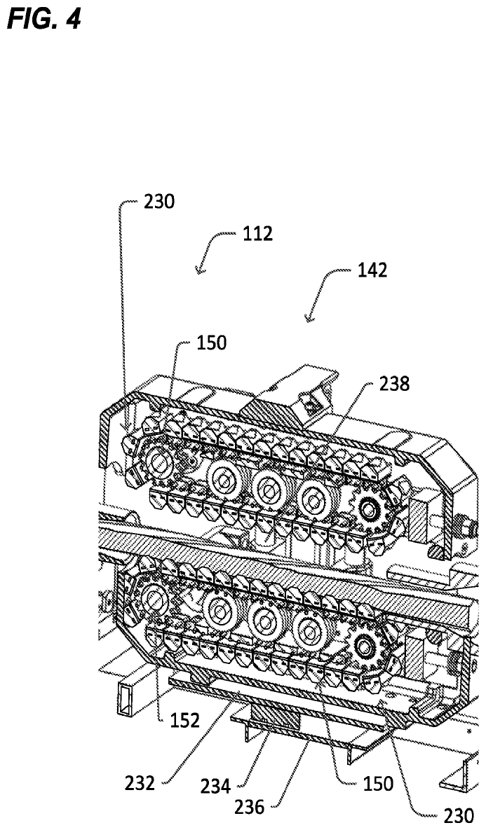

FIG. 4 is a cross-sectional view of the example advancement device 112 within the transmission line installation system 100 of FIG. 1. Specifically, this figure illustrates the advancement device drive assembly 142, which is illustrated and described in relation to the advancement device in FIGS. 2-3. The advancement device drive assembly 142 includes the upper and lower drive motors 150, 152 for driving the upper tractor drive and lower tractor drive, 146, 148, respectively. Driving the upper tractor drive and lower tractor drive 146, 148 turns chains 230 that provide a motive force to the transmission line 110 to advance the transmission line 110. In the example shown, the advancement device drive assembly 142 is mounted to a top surface of a transmission line drive assembly mount plate 232 by four example screws. A pair of transmission line drive assembly mount bearing glides 234 are mounted to a bottom surface of the transmission line drive assembly mount plate 232 by four example screws. As such, there is no relative movement between the advancement device drive assembly 142 and the pair of transmission line drive assembly mount bearing glides 234. A corresponding pair of transmission line drive assembly mount bearing glide tracks are mounted to a top surface of a transmission line drive assembly mount bearing glide track seating plate 236, which is fixed to the mount frame or an integral portion of the mount frame. As such, there is no relative movement between the mount frame and the transmission line drive assembly mount bearing glide track seating plate 236. The upper drive motor 150 and the lower drive motor 152 may be driven by the hydraulic or electric power source 158 linked by at least one power line 238 to the advancement device drive assembly 142.

FIG. 5 is a side perspective view of a mobile cart 270 including a reel 108 and a winch 272. The mobile cart 270 includes the reel stand 106 and reel 108 for dispensing a transmission line 110. Further, a local controller 160 is included to operate the winch 272 and the dispensing of the transmission line 110. The winch 272 may be powered by an electric or hydraulic power source to dispense or retract transmission line 110 to the reel 108.

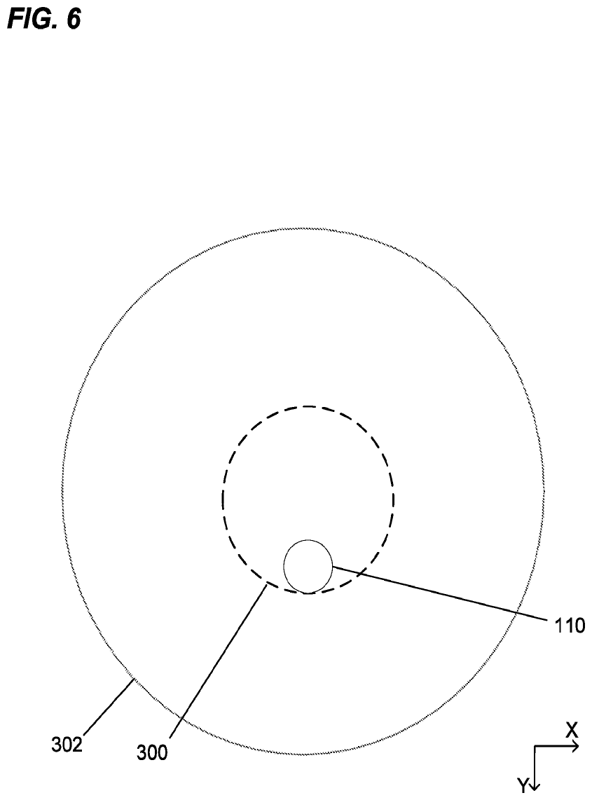

FIG. 6 is a cross-sectional view of a transmission line installed within a conduit and a duct optionally installed within the conduit. The transmission line 110 may be optionally installed within the duct 300. The dashed line denoting the duct 300 indicates the duct 300 is optionally installed within the conduit C. In some embodiments, the transmission line 110 is installed directly within the conduit C. A user may install the conduit C or install a transmission line 110 into a preexisting conduit C. In some embodiments, the conduit C is an oil pipeline installed below the ground. In some embodiments, a plurality of transmission lines 110 may be installed within the conduit C. In some embodiments, the plurality of transmission lines 110 are installed within the conduit C using a plurality of advancement devices 112. In some embodiments, a plurality of transmission lines 110 may be installed simultaneously within the conduit C using a plurality of advancement devices 112.

FIG. 7 is a block diagram illustrating exemplary communications within an example of the transmission line installation system shown in FIGS. 1-4. Similar to the example shown in FIGS. 1 and 2, the example transmission line installation system 100 includes the transmission line conveying system 104, such as including line advancement devices 112. Some embodiments further include one or more of a route evaluation system 330, a remote control and diagnostics system 332, and an installation monitoring and management system 334. The example transmission line conveying system 104 includes the control unit 120 and a plurality of components 340, such as advancement devices 112 and hydraulic or electric power sources 158. In some embodiments the control unit 120 includes and operates as a global controller 338 and the components include local controllers 160.

A fluid injection machine is another example of a component 340. An example of a fluid injection machine is lubricating machine, which is operable to add (apply or inject) lubricant onto the transmission line 110 or into the conduit C. The lubricating machine can be arranged at the start of the run to apply lubricant to the transmission line 110 before it enters the duct, or to inject lubricant into the starting end of the duct. The lubricating machine includes a pump or other lubrication applicator, and includes a local controller operable to interact with the control unit 120 and/or other components 340, and to control the operation of the lubricating machine, such as to adjust the amount of lubricant being added to the transmission line 110 or conduit C, or to tum on or off the addition of lubricant. In some embodiments the lubricating machine has various types of lubricant and can select between those types depending on the conditions, and even adjust the lubricant on the fly as installation proceeds. In another possible embodiment, the fluid injection machine can be integrated into an advancement device 112. In some embodiments, the fluid injection machine can be integrated with and combined with a moisturizer unit and/or an injection fluid tank.

A transmission line cleaner is another example of a component 340, which is operable to clean a transmission line before it enters the transmission line conveying system 104. The transmission line cleaner typically includes one or more cleaning mechanisms (motorized or non-motorized) such as sensors to detect foreign objects such as sand, mud, water, and the like, and determine whether and an extent of cleaning that is required, and then activates the cleaning mechanism to perform the appropriate cleaning. Cleaning mechanisms can include brushes, wipers, and water or other liquid baths. As with other components 340, the transmission line cleaner includes a local controller to permit communication with other components 340, the control unit 120, and operates to control the operations of the cleaning mechanism itself. In some embodiments the cable cleaner is positioned before an optical detector (discussed herein) that reads markings on the exterior of the transmission line. The cleaning removes any obstructions on the markings that might otherwise interfere with the reading by an optical detector.

Some embodiments include a tether mechanism. A tether mechanism operates similarly to a line puller, but instead of pulling the transmission line toward it, it operates instead to provide a back pressure to provide more precise speed control to the transmission line 110, such as when using an advancement device 112 to advance the transmission line through the duct. The tether mechanism typically includes an elongate member (e.g., a tape or cable) that is connected to the transmission line (directly or with a coupler). In some embodiments the elongate member is connected to the line carrier. The line puller is an example of a tether mechanism when it is operated in reverse. In another embodiment, the tether mechanism can include a brake or other controllable slip interface that is operable to apply a braking force to control a speed at which the transmission line is advanced through the conduit C.

The control unit 120 operates as the primary user interface with the installation technician. The control unit 120 prompts the user, such as the installation technician or other user, to provide inputs to control the overall operation of the transmission line conveying system 104, such as start or stop inputs, and to define an installation plan including settings for the system. In some embodiments, the control unit includes both a local communication device as well as a network communication device such as a cellular modem or Wi-Fi communication device. The local communication device can be either a wired or wireless communication system, such as a wired serial communication device (such as a universal serial bus (“USB”) device), or a wireless device (such as utilizing Wi-Fi or BLUETOOTH communication), which allows the control unit to communicate with the components 340 and their local controllers 160. The network communication device enables the control unit 120 of the transmission line conveying system 104 to communicate across the Internet or other network, such as with one or more of the route evaluation system 330, the remote control and diagnostics system 332, and the installation monitoring and management system 334.

The local controllers 160 can communicate with the control unit 120 and/or other local controllers 160. The local controllers 160 are coupled to other sensors or controllable devices within the components 340, and therefore are capable of receiving or generating data associated with the components 340 and are also able to control any controllable devices such as motors, pumps, and the like.

The communications can be used to transmit control commands or data. Control commands are issued by one controller to another controller and instruct the other controller to adjust an operation, such as to speed up or slow down, start or stop, increase or decrease a pull or push force, or other controllable operations.

Data communication is used to transmit information within the system. An example of a data transmission may include a temperature, speed, pressure, humidity, tension or force, or other information. Data may be generated by a sensor or may simply identify a current status or operational parameter of one of the components (e.g., indicating that the device is turned on, or indicating that the device is currently set to operate at a particular speed, etc.). Data received from one controller by another controller can be used by that other controller to react accordingly, such as to adjust its own operation, or may be used by the control unit to send one or more commands to the components 340.

In some embodiments the control unit 120 and plurality of components 340 are configured to communicate with each other according to a predefined communication protocol to automatically identify each other and to make use of resources provided by the connected components. For example, when a first component 340 is added to the transmission line installation system, the first component 340 and the global controller 338 communicate with each other to identify each other and determine the resources (including features and functionality) that are now available to the transmission line installation system 100 as a result. When additional components 340 are added the components are similarly identified. The transmission line installation system 100 can therefore operate in such a way that it utilizes the resources available to it, and similarly can identify any problems or deficiencies in the current system configuration and make recommendations to the operator to change the configuration if needed. When an installation plan is developed, as discussed herein, the plan can be customized based on the specific configuration of the system at that time. Similarly, other parts such as the duct itself, the transmission line or transmission line reel, and the like can also be identified by the transmission line installation system, such as by reading an RFID tag or communicating with a local controller associated with those parts, to identify characteristics of the parts.

In some embodiments the control unit 120 and the components 340 are fully operable individually regardless of whether or not they are connected with the control unit 120 or other components 340. When connected they cooperate with each other to utilize the resources of the others, and when disconnected they operate with whatever resources are available.

In various implementations the transmission line installation system 100 can operate in various different control and communication modes. Several examples include: (1) a master/slave control model in which the control unit 120 operates as a global controller 338, where the control unit 120 is the master device and the local controllers 160 operate as slave devices; (2) a global controller 338 and local controller 160 model utilizing peer-to-peer communication in which the global controller 338 performs an advisory role and the local controllers 160 are capable of operating independently under the advice of the global controller 338; and (3) a peer-to-peer model where the local controllers 160 cooperate but independently control their own components 340, and where the control unit 120 does not attempt to control the individual operations of the components 340, but rather performs the role of a primary interface with the installation technician, to provide the local controllers with instructions received from the installation technician. Other communication and control modes are also possible. As one further example, the global controller 338 can be part of one of the components 340, such as the advancement device 112. In yet another example, the role of a controller 160 as the global controller 338 can be passed from one component 340 to other components during the course of an installation. For example, in some embodiments an advancement device 112A local controller 160 is the global controller while the leading edge of the transmission line 110 is within the duct segment D1 that it controls, and then the global controller status switches to the local controller 160 of the advancement device 112B once the transmission line moves into the next duct segment D2. This can be beneficial because the advancement device 112 associated with the current duct segment may have the most current information about the status of the leading edge of the transmission line, and the other components can provide support to that advancement device 112 in accordance with its instructions.

In some embodiments the global controller 338 includes one or more of a processing device, a memory device, a communication device, a power supply, a display device, and an input device. The communication device can be a wired communication device or a wireless communication device. Data communication can occur through any one of a variety of standard wired or wireless data communication protocols. Examples of wired communication devices include modems, USB devices, serial and other 1/0 communication devices. Examples of wireless communication devices include cellular communication devices, Wi-Fi (IEEE 802.11x) communication devices, BLUETOOTH communication devices, and long range (LoRa) communication devices. The display device generates a user interface for the installation technician, such as a graphical user interface. The input device receives inputs from the installation technician. A touchscreen display can be utilized which includes both the display device and the input device.

The installation monitoring and management system 334 permits a supervisor or other people at a remote location to monitor and manage the transmission line installation system 100, and in some embodiments multiple other transmission line installation systems 100 at other sites. In some embodiments the installation monitoring and management system 334 monitors a status of the transmission line installation system 100, such as the configuration of the system during setup, and the operation of the system during a transmission line installation. In some embodiments the installation monitoring and management system 334 performs fleet management functions, to assign technicians to installation teams, dispatch the teams to project sites, and monitor the progress of the installations. System 334 can also manage schedules, such as to display schedules for the coming days or weeks, and provide historical analysis, reporting, and heuristic data.

An example of a route evaluation system 330 that can perform the route evaluation and segment characterization is described in further detail in PCT Publication WO 2018/090043 (the '043 application), filed on Nov. 14, 2017 and in PCT Publication WO 2016/176467, filed on Apr. 28, 2016, the disclosures of which are hereby incorporated by reference in their entireties. As one example, a duct mapping device (such as the route evaluation device shown in FIG. 27 of the '043 application) is passed through the duct, and includes sensors (such as one or more of an accelerometer, gyroscope, global positioning system receiver, and the like (and may have multiple of these, such as one or more three-axis accelerometers), which map the movement and/or position of the duct mapping device as it moves through the conduit C. A detailed three-dimensional map of the conduit C route can then be generated, such as including a series of X, Y, and Z coordinates defining the position of the conduit C at frequent intervals along the route. The route evaluation system can therefore generate a detailed route map defining the position and features of the conduit C route along the full length of the duct.

In some embodiments the duct mapping device provides the route geometry including, for example, the degrees of bends, the radius of the bends, the cumulative amount of bends, whether a minimum bend radius of the cable is exceeded, and X, Y & Z GPS coordinates of the duct taken at certain intervals, such as at a sampling rate of 100 Hz intervals.

Other examples of duct mapping devices that can be utilized for route evaluation and segment characterization are the mapping tools available from Reduct NV, of Schelle, Belgium, including the ABM-30 gyro mapping tool, ABM-40MEMSbased mapping probe, the ABM-80 and ABM-90 wheeled mapping tools, the DR-2 fiber optic gyroscope mapping probe, DR-3 mapping tool, and DR-4 multi-purpose pipeline mapping system.

FIG. 8 is a schematic block diagram illustrating an example of the local controller 160 of a component of the transmission line installation system 100 shown in FIG. 4.

The same or similar local controller 160 can be used with any of the components 340 of the transmission line installation system 100. Examples of the components 340 that can include the local controller 160 include power sources, advancement devices 112 (or other transmission line conveying apparatus), an air heater, an air cooler, an air humidifier, an air dryer, a static charge elimination device, a moisturizer, and a lubricator. Other components of the transmission line installation system 100 may also include a local controller if data communication, synchronization, or control of the component is desired. In some embodiments the control unit 120 can include a local controller, for example, in some embodiments the control unit 120 is integrated with another component, such as the advancement device 112.

The local controller 160 controls the overall operation of the component 340, and communicates through the communication device 364 with one or more other components 340 of the transmission line installation system 100. For example, in some embodiments the local controller 160 receives commands in the form of messages or instructions from the control unit 120 through the communication device 364. Examples of such commands include start, stop, and speed adjustments (a particular speed setting, an instruction to increase the speed, or an instruction to decrease the speed, etc.). Further, in some embodiments the local controller 160 also sends messages or instructions to other components through the communication device 364. For example, measured data or current or historical settings can be transmitted by the local controller 160 to other components.

The processing device 360 operates to process data instructions to perform functions of the component 340. The memory device 362 stores data instructions, which when executed by the processing device 360, cause the processing device to perform those functions. The memory device 362 does not include transitory media carrying data signals. An example of the memory device 362 is a non-transitory computer readable storage device as described in further detail herein.

The communication device 364 is a device that communicates with other devices via wired or wireless data communication. In some embodiments the communication device 364 communicates with one or more of the control unit 120 and other components of the system 100.

The communication device 364 can utilize wireless or wired communication devices. Examples of wireless communication devices include cellular communication devices, Wi-Fi (IEEE 802.11x) communication devices, and BLUETOOTH communication devices. Wired communication devices include modems, USB devices, serial and other 1/0 communication devices and techniques.

The intracomponent input/output communication device 366 operates to communicate with and control subsystems, sensors, or other electronic or controllable devices within the component 340, utilizing wired or wireless communication or control signals. For example, the intracomponent input/output communication device 366 is coupled to and controls mechanical, pneumatic, or electronic components such as motors, brakes, sensors (e.g., temperature, moisture, transmission line tension, speed, line counter, etc.).

Examples of processing devices, memory devices (including computer readable storage devices), and communication devices are described herein with reference to an example computing device, and also with reference to the local controllers, and such descriptions similarly apply to the processing device 360, memory device 362, and communication device 364 of the example local controller 160 shown in FIG. 7.

FIG. 9 is a schematic block diagram illustrating another example of the local controller 160 of a component of the transmission line installation system 100 shown in FIGS. 4 and 8. This figure illustrates an exemplary architecture of a computing device that can be used to implement aspects of the present disclosure, including any of the plurality of the computing devices described herein, including the control unit 120, global controller 338, and any other computing device involved in the transmission line installation system 100.

Further, the computing device can also be implemented as part of any one or more of the transmission line installation system 100 components discussed herein, such as a portion of the reel stand 106, the transmission line conveying system 104 (including the power source 116, and/or the advancement device 112). The computing device can be used to execute the operating system, application programs, and software modules (including the software engines) described herein. By way of example, the computing device will be described below as an example of the control unit 120. To avoid undue repetition, this description of the computing device will not be separately repeated herein for each of the other computing devices, including those listed above, but such devices can also be configured as illustrated and described with reference to FIG. 9.

In this example, the control unit 120 includes a computing device 370. The computing device 370 can be used to execute the operating system, application programs, methods, and software modules, and to perform any one or more of the functions of the control unit 120, described herein.

The computing device 370 includes, in some embodiments, at least one processing device 372, such as a central processing unit (CPU). A variety of processing devices are available from a variety of manufacturers, for example, Intel or Advanced Micro Devices. In this example, the computing device 370 also includes a system memory 374, and a system bus 376 that couples various system components including the system memory 374 to the processing device 372. The system bus 376 is one of any number of types of bus structures including a memory bus, or memory controller; a peripheral bus; and a local bus using any of a variety of bus architectures. Examples of computing devices suitable for the computing device 370 include a server computer, a desktop computer, a laptop computer, a tablet computer, a mobile computing device (such as a smart phone, an iPod® or iPad® mobile digital device, or other mobile devices), or other devices configured to process digital instructions.

The system memory 374 includes read only memory 378 and random access memory 380. A basic input/output system 382 containing the basic routines that act to transfer information within computing device 370, such as during start up, is typically stored in the read only memory 378. The computing device 370 also includes a secondary storage device 384 in some embodiments, such as a hard disk drive, for storing digital data. The secondary storage device 384 is connected to the system bus 376 by a secondary storage interface 386. The secondary storage devices 384 and their associated computer readable media provide nonvolatile storage of computer readable instructions (including application programs and program modules), data structures, and other data for the computing device 370.

Although the exemplary environment described herein employs a hard disk drive as a secondary storage device, other types of computer readable storage media are used in other embodiments. Examples of these other types of computer readable storage media include magnetic cassettes, flash memory cards, digital video disks, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 384 or memory 374, including an operating system 388, one or more application programs 390, other program modules 392 (such as the software engines described herein), and program data 394. The computing device 370 can utilize any suitable operating system, such as Microsoft Windows™, Google Chrome™, Google Android, Apple OS, Apple iOS, Linux, and any other operating system suitable for a computing device.

In some embodiments, a user provides inputs to the computing device 370 through one or more input devices, such as the touch sensitive display 398. Other input devices can also be used, such as a keyboard, mouse, pointer control device (such as a touch pad, touch stick, joy stick, etc.), microphone, and any other suitable input device. The input devices are often connected to the processing device 372 through an input/output interface 396 that is coupled to the system bus 376. Wireless communication between input devices and the interface 396 is possible as well, and includes infrared, BLUETOOTH® wireless technology, IEEE 802.11x Wi-Fi technology, cellular, or other radio frequency communication systems. Therefore, in some embodiments the 1/0 interface is a wireless communication device.

One or more input/output interfaces 396 can be used for communicating with other components of the transmission line installation system 100, such as the transmission line source 102, and transmission line conveying system 104. The input/output interface can include AC, DC, or digital input output interfaces, including for example USB and other i/o interfaces, and can also or alternatively include one or more communication devices such as a wireless communication device, wired network communication device (e.g., a modem or Ethernet communication device), or other wired communication devices (e.g., serial bus). The 1/0 interface 396 can communicate with the local controllers 160 of other components of the transmission line installation system 100, for example. In some embodiments the communication includes communication of data and commands. Examples of data include sensor data, such as a temperature, humidity, transmission line length, transmission line speed, reel feed speed, and other data describing current operating conditions. Examples of commands include start, stop, setting adjustments, and the like.

In this example embodiment, a display device 398, such as a monitor, liquid crystal display device, projector, or touch sensitive display device, is also connected to the system bus 376 via an interface, such as a video adapter 400. In addition to the display device 398, the computing device 370 can include various other peripheral devices (not shown), such as a wireless headset, speakers, and a printer.

When used in a local area networking environment or a wide area networking environment (such as the Internet), the computing device 370 is typically connected to a network 404 through a network interface 402, such as an Ethernet interface, or by a wireless communication device, such as using cellular or Wi-Fi communication. In some embodiments the network interface 402 is a cellular modem that can access the Internet through a cellular network. The network interface 402 can communicate with remote systems, such as a route evaluation system.

The computing device 370 typically includes at least some form of computer readable media. Computer readable media includes any available media that can be accessed by the computing device 370. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 370. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

In some embodiments the computing device 370 includes or is connected to a location determining device, such as a global positioning system (GPS) receiver.

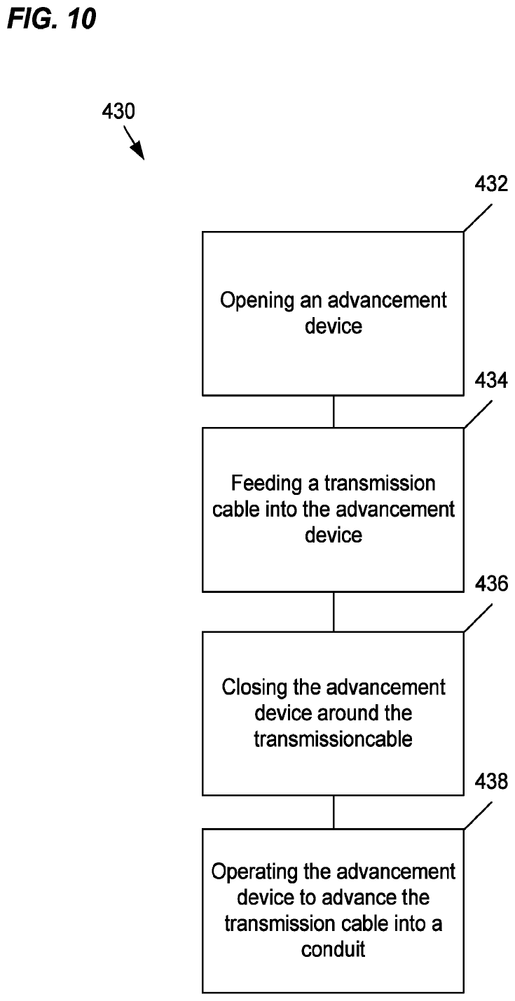

FIG. 10 is a flow chart illustrating a method 430 for using an advancement device to advance a transmission line into a conduit. The method 430 includes the steps of opening the advancement device 432, feeding a transmission line into the advancement device 434, closing the advancement device around the transmission line 436, and operating the advancement device to advance the transmission line into a conduit 438.

The step of opening the advancement device 432 may include a preliminary step of preparing a transmission line 110 to be installed fed into the advancement device 112.

The step of feeding a transmission line into the advancement device 434 includes feeding the transmission line through the upper tractor drive 146 and the lower tractor drive 148 of the advancement device drive assembly 142. Furthermore, the transmission line 110 may be fed through the line counter assembly 140 to monitor the length of the transmission line 110 passing through the advancement device 112 from the reel 108.

The step of closing the advancement device around the transmission line 436 includes securing the transmission line 110 between the upper tractor drive 146 and the lower tractor drive 148 of the advancement device drive assembly 142.

The step of operating the advancement device to advance the transmission line into the conduit 438 includes supplying hydraulic or electric power from a hydraulic or electric power source 158 to an upper drive motor 150 and a lower drive motor 152 to operate the upper tractor drive 146 and the lower tractor drive 148. A local controller 160 may be used to control the drive motors 150, 152 as illustrated and described in further detail in FIGS. 2, 7, and 8.

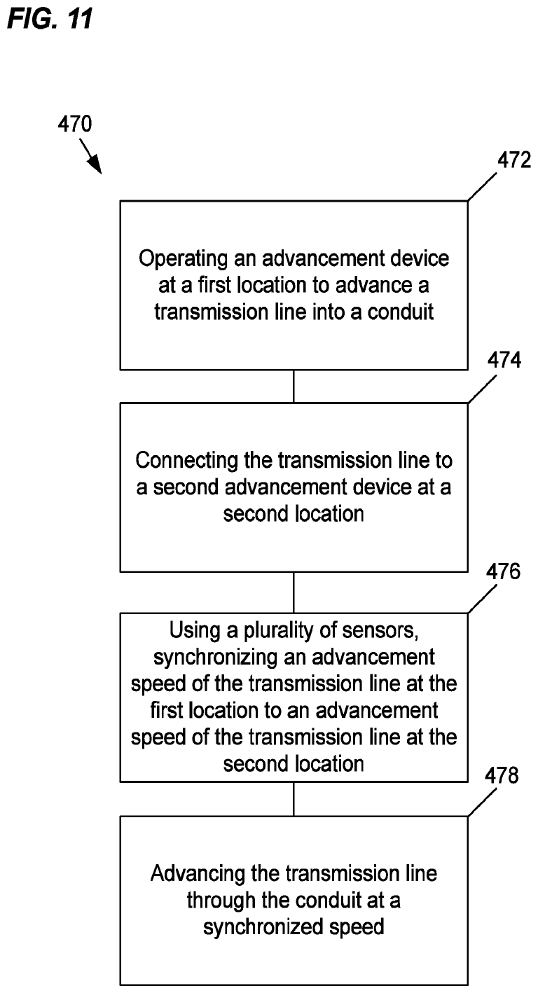

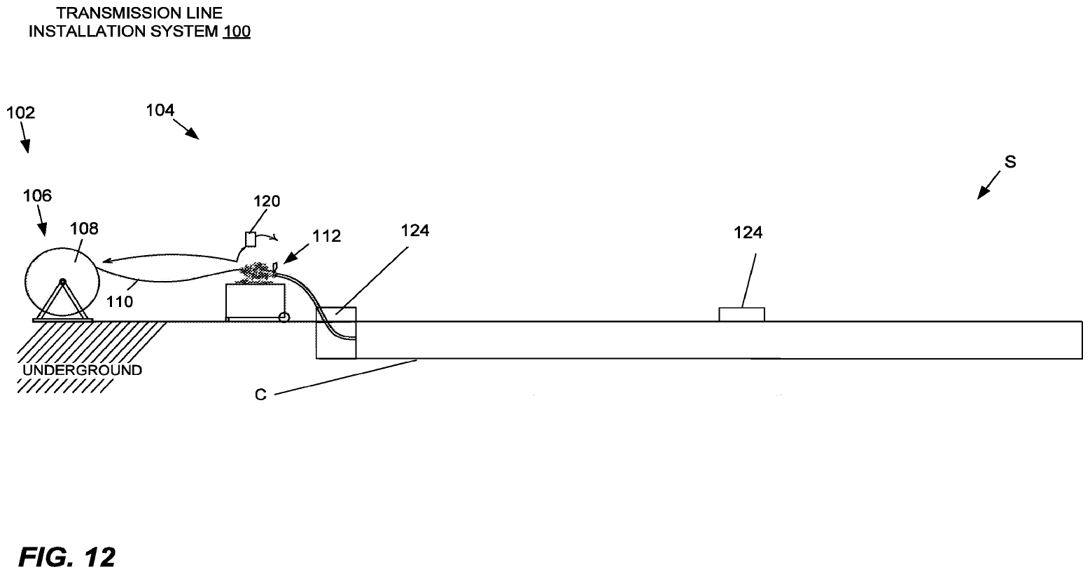

FIG. 11 is a flow chart illustrating a method 470 for using a transmission line installation system including a plurality of advancement devices to advance a transmission line through a conduit. The method 470 includes steps of operating an advancement device at a first location to advance a transmission line into a conduit 472; connecting the transmission line to a second advancement device at a second location 474; using a plurality of sensors, synchronizing an advancement speed of the transmission line at the first location to an advancement speed of the transmission line at the second location 476; and advancing the transmission line through the conduit at a synchronized speed 478. These steps are illustrated and described in further detail with respect to FIGS. 12-14.

FIG. 12 is a schematic diagram illustrating a step of the method of FIG. 11 wherein a first advancement device advances a transmission line below the ground. In some embodiments, the step of operating an advancement device at a first location to advance a transmission line into a conduit 472 is similar to the method described in FIG. 10, wherein the first advancement device 112A is opened, transmission line 110 is fed through the first advancement device 112A, the first advancement device 112A is secured around the transmission line 110, and the transmission line 110 is driven into a conduit by the first advancement device 112A.

This figure illustrates the transmission line 110 being dispensed from the reel 108 through an advancement device 112 that is controlled by a control unit 120. The advancement device 112 advances the transmission line 110 into an access opening 124 to advance the transmission line 110 through a conduit C below the ground. In some embodiments, the advancement device 112 advances the transmission line through a conduit C above the ground. In some embodiments, multiple access openings 124 may be placed along the conduit C at a predetermined distance based on the maximum range the advancement device 112 is configured to advance the transmission line 110.

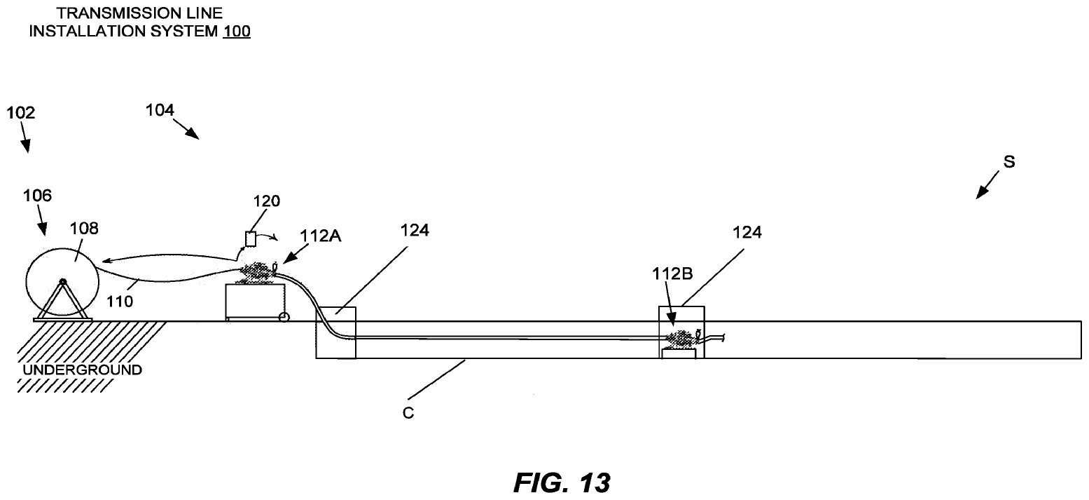

FIG. 13 is a schematic diagram illustrating a additional steps of the method of FIG. 11, wherein the transmission line is connected to a second advancement device, an advancement speed at the first advancement device and the second advancement device are synchronized, and then the first advancement device and the second advancement device further advance the transmission line through the conduit.

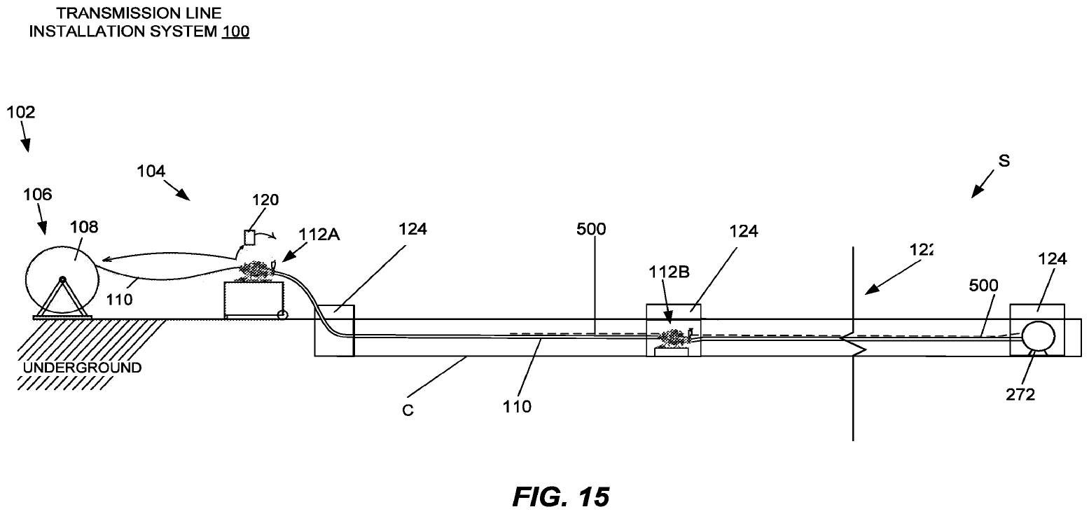

This figure includes similar components as illustrated and described in FIG. 12. In this figure, the transmission line installation system 100 includes a plurality of advancement devices 112A, 112B located within access openings 124 that are configured to provide a user access to the advancement devices 112A, 112B. A user may access the second advancement device 112B through the access opening 124 at a second location to connect the transmission line 110 to the second advancement device 112B after the first advancement device 112A has advanced the transmission line 110 to the second location. In some embodiments, the second advancement device 112B may include a pulling cord 500 configured to couple to the transmission line 110 and connect the transmission line 110 to the second advancement device 112B by pulling the transmission line 110 to the second advancement device 112B. The pulling cord 500 is illustrated and described in further detail with respect to FIG. 15.

In some embodiments advancement devices 112A, 112B, include sensors to synchronize an advancement speed of the transmission line 110 at the first location through the first advancement device 112A to an advancement speed of the transmission line at the second location through the second advancement device 112B. In some embodiments, these sensors are load cells 200. Once the speed of the transmission line 110 is adjusted at the first and second location by the advancement devices 112A, 112B, the advancement devices 112A, 112B may communicate with one another using a control unit 120 including a global controller 338 configured to communicate between the advancement devices 112A, 112B to advance the transmission line 110 at a synchronized speed. In some embodiments, the pulling cord 500 may couple to the transmission line 110 automatically as the first advancement device 112A advances the transmission line 110 to the second position. As the pulling cord 500 automatically couples to the transmission line 110, the pulling cord 500 feeds the transmission line into the second advancement device 112B without any input from a user. This desirable because it eliminates a need for a user to connect the transmission line 110 to the second advancement device 112B at the second location by entering through an access opening 124.

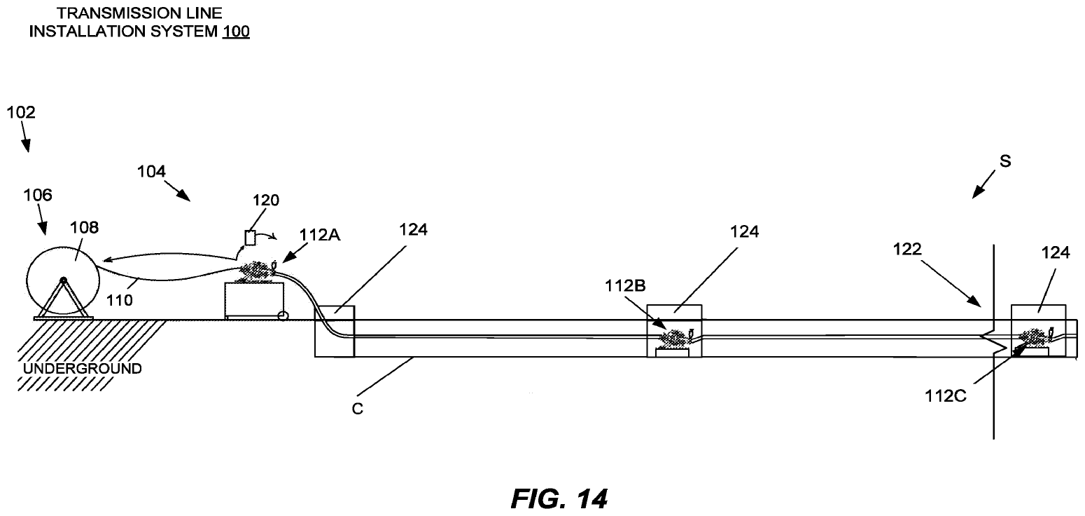

FIG. 14 is a schematic diagram illustrating optional steps of the method of FIG. 11, wherein the transmission line 110 may be connected to subsequent advancement devices after the second advancement device and further advanced through the conduit.

This figure includes similar components as illustrated and described in FIGS. 12-13. In this figure, a break 122 denotes a possibility of a large distance between advancement devices 112, In some embodiments, the reel 108 may store dispense at least 10,000 feet of power cable. In some embodiments, more than two advancement devices 112 are used to advance the transmission line 110. This may include a third advancement device 112C or any number of subsequent advancement devices 112 as necessary to advance the transmission line 110 a desired distance.

FIG. 15 is a schematic diagram illustrating the transmission line installation system 100 of FIGS. 1 and 15 including pull lines and a winch 272 positioned at a second end of the transmission line installation system.

This figure includes similar components as illustrated and described in FIGS. 12-14. In this figure, a pulling cord 500 is shown coupled to the transmission line 110 to feed the transmission line 110 into an advancement device 112B. The pulling cord 500 is attached to a winch 272 that is positioned at an end of the transmission line installation system 100 opposite the reel 108 to assist in pulling the transmission line 110 through the conduit C. In some embodiments, the pulling cord 500 (denoted by a dashed line) is configured to automatically couple to the transmission line 110 within the conduit C to guide the transmission line 110 to a subsequent advancement device 112 along the conduit C or to an end of the transmission line installation system 100 at the winch 272. The winch 272 supplies an additional pulling force to assist in advancing the transmission line 110 along the conduit C. The winch 272 and pulling cord 500 provide multiple advantages, namely providing additional force to advance transmission lines 110 great distances while automatically guiding the transmission lines 110 to an advancement device 112 without the aid of a user. In some embodiments, the transmission line is a power cable, which has a greater mass than other transmission lines such as fiber optic cables. The use of advancement devices 112 with the assistance of a pulling cord 500 and a winch 272 is desirable for advancing power cables.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

What is claimed is:

1. An advancement device comprising:
a control unit comprising a processing device, a computer-readable storage device, a communication device, a display device, and at least one input device, the control unit being configured to display status information and to receive input from a user;
a transmission line source configured to supply a transmission line to an advancement device drive assembly;
the advancement device drive assembly, the advancement device drive assembly configured to advance at least one transmission line through a conduit;
a local controller, the local controller configured to control various components of the advancement device and communicate with a global controller, wherein the local controller is configured to communicate with other advancement devices via the global controller to synchronize the operation of a plurality of advancement devices; and
a power source configured to power the local controller.

2. The advancement device of claim 1, further comprising a line counter assembly configured to monitor the length of the transmission line passing through the advancement device.

3. The advancement device of claim 1, wherein the advancement device drive assembly further comprises an upper tractor unit and a lower tractor unit configured to advance the transmission line through the conduit.

4. The advancement device of claim 3, wherein the advancement device drive assembly further comprises an upper drive motor configured to actuate the upper tractor unit and a lower drive motor configured to actuate the lower tractor unit.

5. The advancement device of claim 4, wherein the advancement device drive assembly further comprises a power source configured to supply electric or hydraulic power to the upper drive motor and the lower drive motor.

6. The advancement device of claim 1, further comprising a drive counter configured to measure the movement of the lower tractor drive to calculate a speed of the transmission line.

7. The advancement device of claim 1, further comprising a clamp configured to generate a predetermined normal force on the transmission line between the upper tractor drive and the lower tractor drive.

8. The advancement device of claim 1, wherein the transmission line source is coupled to a portable cart.

9. The advancement device of claim 8, wherein the portable cart further comprises a reel for storing and dispensing the transmission line.

10. A transmission line installation system comprising:
a control unit comprising a processing device, a computer-readable storage device, a communication device, a display device, and at least one input device, the control unit being configured to display status information and to receive input from a user;
a transmission line source configured to supply a transmission line to an advancement device drive assembly;
a plurality of advancement devices, the plurality of advancement devices configured receive a transmission line at a drive assembly first end and advance the transmission line into a conduit at a drive assembly second end, wherein the plurality of advancement devices comprise a sensor for measuring a speed of the transmission line as it is advanced by the plurality of advancement devices;
a plurality of local controller configured to communicate with other local controllers positioned in other advancement devices via a global controller, wherein the local controllers are configured to communicate the measured speed of the transmission line as it is advanced through each of the plurality of advancement devices to each of the other plurality of advancement devices via the global controller, wherein the local controllers are configured to receive the measured speed of each of the other local controllers via the global controller and synchronize the speed of the transmission line as it passes through each advancement device; and
a power source configured to power the plurality of local controllers.

11. The transmission line installation system of claim 10, further comprising access points configured to allow a user to access the transmission line and the advancement device within a conduit.

12. The transmission line installation system of claim 11, wherein the access points are positioned at a predetermined distance from one another based on a maximum distance the advancement devices are configured to advance the transmission line.

13. The transmission line installation system of claim 10, wherein the transmission line source is coupled to a portable cart.

14. The advancement device of claim 13, wherein the portable cart further comprises a reel for storing and dispensing the transmission line.

15. A method of retrofitting a pipeline with a power cable using a transmission line installation system, comprising:
accessing the pipeline at a first location through a first access point;
operating a first advancement device at the first location to advance the power cable to a second location;
connecting the power cable to a second advancement device at the second location;
operating the second advancement device at the second location to advance the power cable to a desired location;
using a plurality of sensors, measuring a speed of the transmission line at the first advancement device and the second advancement device as the transmission line passes through the first advancement device and the second advancement device;
using a local controller at each of the advancement devices, communicating the measured speed with the other advancement devices along the transmission line installation system via a global controller; and
using the local controller at each of the advancement devices, adjusting the speed of the transmission line as it passes through each of the advancement devices to a uniform speed.

16. The method of retrofitting a pipeline with a power cable of claim 15, further comprising:
closing the pipeline at the first location by sealing the first access point; and
closing the pipeline at the second location by sealing a second location access point.

17. The method of retrofitting a pipeline with a power cable of claim 15, further comprising connecting a pull cord to the power cable to guide the power cable to the second advancement device.

18. The method of retrofitting a pipeline with a power cable of claim 15, further comprising pulling the pull cord toward an end of the pipeline opposite the first position using a winch, wherein the pull cord is connected to a winch at an end of the transmission line installation system opposite the first location.
